(19) United States
(12) Patent Application Publication
(10) Pub. No.: US 2013/0018723 A1
(43) Pub. Date: Jan. 17, 2013

(54) SEARCH-AWARE CONDITIONAL BIDDING ON ADVERTISEMENT DISPLAY

(71) Applicant: Amit KHANNA, Sunnyvale, CA (US)

(72) Inventor: Amit KHANNA, Sunnyvale, CA (US)

(21) Appl. No.: 13/181,365

(22) Filed: Jul. 12, 2011

(51) Int. Cl. G06Q 30/00

(52) U.S. Cl. 705/14.49

(57) ABSTRACT

Systems, methods, and computational solutions are discussed herein relating to the selection and assignment of show and no-show bids to advertisements based on overlap and/or association between search results and advertisements presented in conjunction therewith. Advertisers may provide ads with show and no-show bids to vary ad presentation cost based on search results. Systems and methods for enabling and enacting such bid and ad display techniques are disclosed herein.

### BACKGROUND

When performing a search for goods or services, the most relevant ad may also be the most relevant search result. In such cases, a user may click on a search result instead of clicking on the ad and get the same net effect of being directed to a particular site/product/result. Alternately, some advertisers may wish to reinforce the impression created by their product by having an advertisement for their good/service displayed directly above the most relevant search result to reinforce the relevance of the search result.

### SUMMARY

Variations of the solutions discussed herein pertain to a method of dynamically establishing a bid for a search advertisement having a show bid and a no-show bid. Variations of such a method may comprise steps of: selecting at least one advertisement for display in response to a user-initiated search, said advertisement having an associated show bid and a no-show bid; determining if the selected at least one advertisement is associated with at least one of a predetermined number of top-ranked search results; setting a show bid for said at least one advertisement if said determining indicates that said at least one advertisement is associated with said search results; setting a no-show bid for said at least one advertisement if said determining indicates that said at least one advertisement is not associated with said search results; and serving at least one of said at least one advertisement along with said search results.

Other variations of the solutions discussed herein pertain to a method of serving an advertisement to a data access device along with search results. Variations of such a method may comprise steps of: receiving an advertisement request at an ads server; performing an initial ad selection based on said advertisement request; identifying, from among the initially selected ads, those ads having show and no-show bids; receiving, in an ad mixer portion of the ads server, the search results; comparing the identified ads with the search results to determine which of the search results are associated with at least one identified ad; if a search result is determined to be associated with a particular identified ad, selecting a show bid for that identified ad; if no search result is determine to be associated with a particular identified ad, selecting a no-show bid for that identified ad; and serving at least one particular identified ad in response to the advertisement request.

In some variations, receiving the search results includes getting search results from a search engine with the ad mixer. In other variations, receiving an advertisement request includes receiving an advertisement request from at least one of a search engine and a search engine proxy. In yet other variations, the advertisement request from the search engine is based on query-expanded search terms. In other variations stills, getting the search results includes getting the top three search results.

In some variations, serving includes ranking the compared ads according to the bid selected for each ad; and serving one or more top-ranked ads in response to the advertisement request. In yet further variations, serving includes serving said ad for presentation along with said search results. In other variations, serving includes serving the top-ranked ad.

In some variations, determining includes comparing said top-ranked search results to the advertisement according to at least one of URL, phone number, address, and keyword. In other variations, serving includes ranking and rating at least two advertisements based on their associated bids; and serving one or more advertisements based on their rank and rating. In yet other variations, determining includes comparing an edit distance between at least one keyword in said advertisement and at least one keyword in said search results.

In some variations, setting a show bid including subtracting a show decrement amount from the no-show bid to establish a show bid, said show decrement amount being established by the advertiser for said advertisement. In further variations, said show decrement amount including at least a first show decrement amount associated with a first-ranked search result and a second show decrement amount associated with a second-ranked search result, wherein said setting a show bid step includes subtracting the first show decrement amount when said determining indicates said advertisement is associated with a first-ranked search result and subtracting the second show decrement amount when said determining indicates said advertisement is associated with a second-ranked search result; and further wherein a show-bid amount of less than zero is treated as a zero bid.

Yet further variations of the solutions discussed herein may pertain to one or more non-transitory computer-readable media having embodied thereon part or all of one or more programs which, when executed by one or more processors, causes said processors to perform part of all of one or more variations of the method(s) discussed above.

Even further variations of solutions discussed herein pertain to an ads server configured to serve search ads having a show bid and a no-show bid in conjunction with search results, the server comprising: an advertisement request reception portion that receives an advertisement request; an initial ad selection portion that selects an initial set of ads from an ads database based on the advertisement request; a conditional bid ad identification portion that identifies result-contingent ads in the initial set having show bids and no-show bids; an ad mixer portion that receives search results associated with the advertisement request from a search engine; and determines if each of the result-contingent ads is associated with at least one of the received search results; a bid selection portion that selects a show bid for a result-contingent ad when the ad mixer determines that the result-contingent ad is associated with at least one of the received search results; and selects a no-show bid for a result-contingent ad when the ad mixer determines that the result-contingent ad is not associated with at least one of the received search results; such that each of the initially selected ads is associated with a single bid value as a result of bid selection; a best ad selection portion that best selects one or more ads according to one or more selection criteria from among the bid selected ads; and an ad serving portion that serves one or more of the best selected ads.

In some variations, the best ad selection portion is an ad ranking system that ranks the bid selected ads according to at least one of bid, click-through-rate (CTR), and keyword relevance and best selects at least one top-ranked ad. In other variations, the bid selection portion is included in the ad mixer. In yet other variations, the ad mixer and bid selection portions are not engaged in the ad serving process when the conditional bid identification portion does not identify any result-contingent ads in the initial set.

Further scope of applicability of the systems and methods discussed will become apparent from the detailed description given hereinafter. However, it should be understood that the detailed description and specific examples, while indicating preferred embodiments of the systems and methods, are given by way of illustration only, since various changes and modifications within the spirit and scope of the concepts disclosed herein will become apparent to those skilled in the art from this detailed description.

### BRIEF DESCRIPTION OF THE DRAWINGS

The systems and methods discussed will become more fully understood from the detailed description given herein below and the accompanying drawings which are given by way of illustration only, and thus are not limitative, and wherein:

FIG. 1 depicts a block diagram of an embodiment of an ad serving system as discussed herein;

FIG. 2 shows a block diagram of a ranking process that allows for search-contingent bids by advertisers as discussed herein;

FIG. 3a shows a flowchart of an embodiment of an ad selection, ranking, and serving process that addresses show and now-show bidding strategies for search-based advertisement presentation as discussed herein;

FIG. 3b shows an embodiment of search results from a search engine and an embodiment of ads from an ads database and the bids associated with the ads;

FIG. 3c depicts a variation of an ad-to-result comparison and bid selection process;

FIG. 3d depicts a variation of an ad-to-result comparison and bid selection process;

FIG. 3e depicts a variation of an ad-to-result comparison and bid selection process;

FIG. 3f depicts a flowchart of an embodiment of an overall comparison/matching process for identifying ads, ad content, ad landing page targets, and ad-related content within search results;

FIG. 4a depicts a block diagram of an embodiment of an ad serving system as discussed herein;

FIG. 4b depicts a block diagram of an embodiment of an ad serving system as discussed herein; and

FIG. 5 shows a block diagram of an ad selection and serving process that allows for search-contingent bids by advertisers as discussed herein; and

FIG. 6 shows a block diagram of an ad selection and serving process that allows for search-contingent bids by advertisers as discussed herein.

The drawings will be described in detail in the course of the detailed description.

### DETAILED DESCRIPTION

The following detailed description refers to the accompanying drawings. The same reference numbers in different drawings identify the same or similar elements. Also, the following detailed description does not limit the concepts discussed. Instead, the scope of the concepts discussed herein is defined by the appended claims and equivalents thereof.

In ad serving systems, advertisers provide a bid associated with a particular advertisement and/or advertisement display scenario. An advertiser may provide a simple bid for ad presentation with respect to keywords or other triggering behavior. In variations that present/serve multiple ads at once, it may be desirable to allow advertisers to present one or more conditional bids related to things like advertisement rank order.

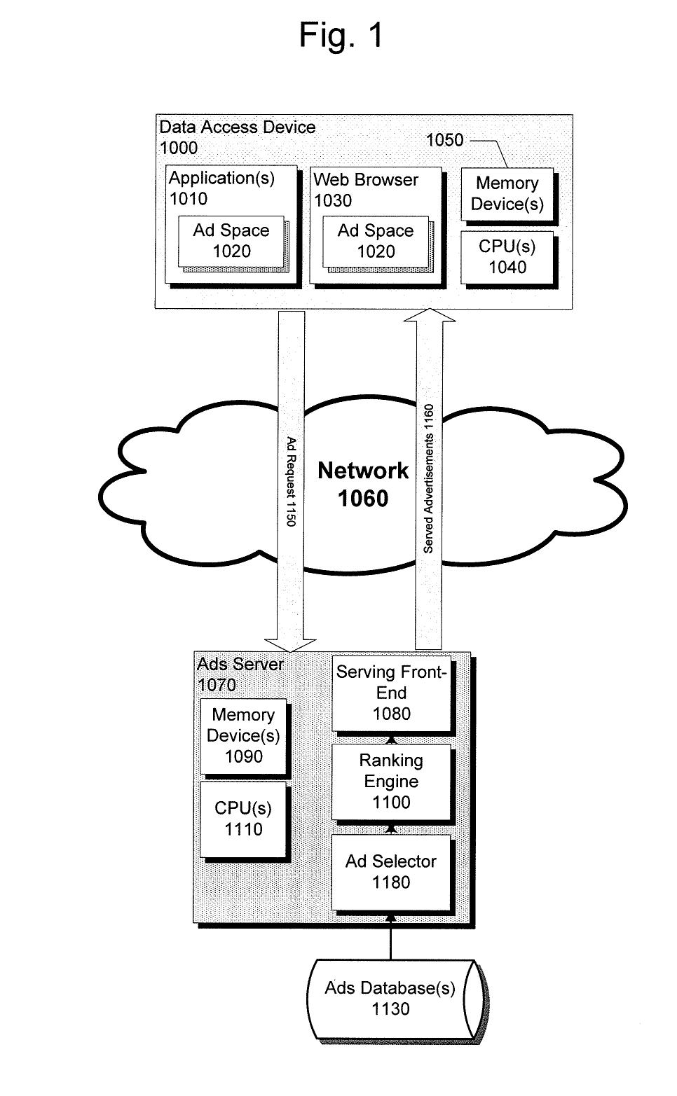

FIG. 1 depicts a block diagram of an embodiment of an ad serving system 1070 that employs a ranking engine 1100 to serve relevant ads 1160 in response to requests 1150 from a data access device 1000.

In the embodiment shown, a data access device 1000 communicates with an ads server 1070 over a network 1060. Embodiments of a data access device 1000 may include a mobile device such as a cellular phone, personal digital assistant, smart-phone, GPS device, tablet, media player or presentation device, netbook and/or notebook computer, or other portable or semi-portable computing and/or data access and presentation device. Other embodiments of a data access device 1000 may include desktop or fixed location computing and/or media access devices, information kiosks, and virtual devices such as software applications, media access programs, and/or web browsing tools.

Embodiments of a data access device 1000 may include one or more memory devices 1050 for information storage and one or more processors 1040 for data processing. The memory devices(s) 1050 and processor(s) 1040 may operate in concert to run one or more applications 1010 such as data exchange, media display, information search, social network, game and/or GPS/location programs.

In some variations, one or more of these applications 1010 may be equipped with ad space 1020 for the display and/or presentation of ads 1160 transmitted via the network 1060 to the data access device 1000 from one or more ad servers 1070. The memory 1050 and processor 1040 may also operate in concert to run one or more web browsing applications or services 1030. Embodiments of a web browser may include application- or app-based browsers or a built-in web browsing tool included in an operating system. Embodiments of a web browser 1030 may also be equipped with ad space 1020 for the display and/or presentation of ads 1160 transmitted via the network 1060 to the data access device 1000 from one or more ad services.

Embodiments of a network 1060 may include public, private, cellular, telephone, radio-frequency, Ethernet, optical, encrypted, open, IP-based, wide-area, local-area, and/or hard-wired data transfer pathways, and/or combinations thereof, suitable for exchange of information between two or more devices connected thereby.

Embodiments of an ads server 1070 may include one or more computing devices or components thereof, which may be configured to operate collectively, independently, or otherwise collaboratively to serve ads 1160 in response to advertisement requests 1150 from a data access device 1000.

Embodiments of an ads server 1070 may include one or more memory devices 1090 for information storage and one or more processors 1110 for data processing. The memory device(s) 1090 and processor(s) 1110 may operate in concert to execute the various functions and aspects and run the associated applications of the ads server. In some variations, an ads server may be equipped with modules, functional units, sub-systems, or programs/applications or portions thereof that perform ad selection and ranking 1100 (and the attendant log database 1120 and ad database 1130 interface features).

Embodiments of ad selection 1180 and ranking 1100 systems and ad serving front-end 1080 may function independently, collectively, and/or interoperably. In some variations, the ad ranking system 1100 may be an associated dedicated server connected to or integrated with an ads database 1130. In other variations, an ad selection 1180 and ranking tool 1100 may be a program or a functional module of an overall ads server application or applications suite. The ad selection 1180 and ranking 1100 aspects may be configured to access or otherwise interface with an ads database 1130 in order to identify and extract from the ads database 1130 ads relevant to an incoming ad request 1150.

Embodiments of ad selection 1180 and ranking 1100 systems may include a ranking feature that ranks each extracted advertisement according to one or more ranking schemes such as auctions, joint-ranking models, and/or other ranking schemes. Embodiments may also include a keyword analysis and/or semantic analysis and search feature that enables an ad selector 1180 to select relevant ads from the ads database 1130 in response to the ad request 1150.

Embodiments of a ranking system 1100 may be realized through programs or program modules running on the ad server(s) 1070 and/or through dedicated hardware systems or modules for the express purpose of ranking ads. In some embodiments, the ranking system may be functionally intertwined with the ad selector 1080 such that both are part of the same program, program portion and/or hardware system or module.

In some variations, an ad serving system 1070 may have a distinct ad selector portion 1180 separate from a ranking system 1100 or may be comprised of a collection of disparate specialized sub-systems. In some variations, an ad selector 1180 may be a specialized database querying unit that is configured to quickly retrieve advertisements from an ads database 1130 based on a relevance determination process performed on an incoming ad request 1150. In other variations, an ad selector 1180 may be a filtering unit configured to winnow down relevant ads identified and retrieved or otherwise indicated from one or more ads databases 1130 by a relevance determination process carried out separately from the ad selector 1180. In yet other variations, the ad selection aspect 1180 may be an integral part of the ranking engine 1100.

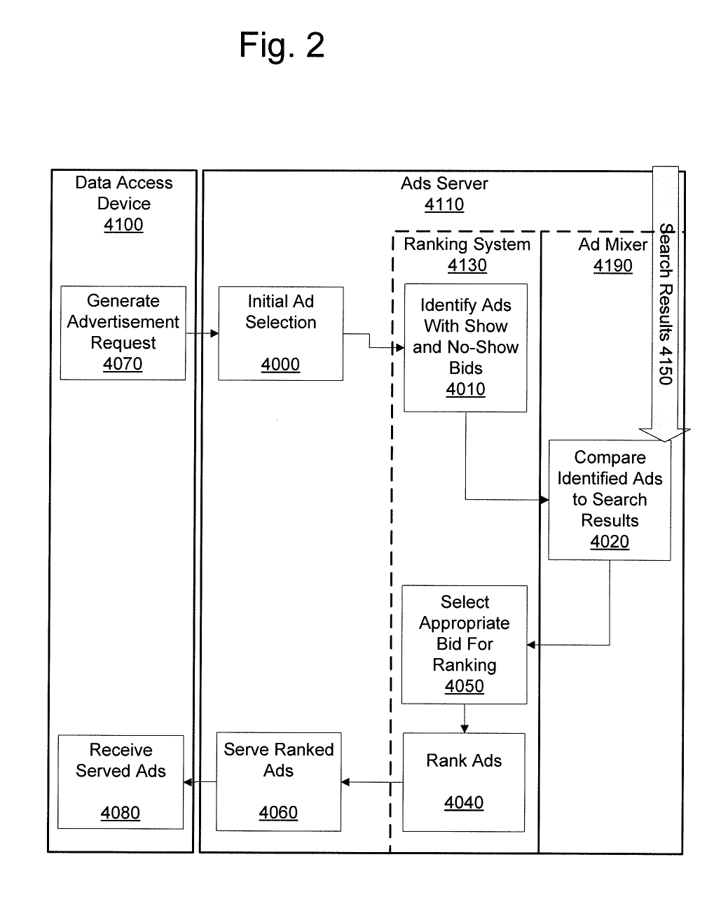

In some variations, the ranking system 1100 may be configured to address/enable an advertiser bidding strategy whereby a bid for an ad display event is conditioned upon results of a query or search associated with that ad display event. In such variations, a data access device 1000 may, via a web browser 1030 or application 1010, input a query into some form of search engine, such as a web or Internet search engine. The search query may also trigger an advertisement request 1150 based on the query terms. An ad selector 1180, upon receipt of the ad request 1150, may select some advertisements having a bid predicated on whether a link and/or site associated with that advertisement is included in the search results for the query. In such a variation, the ranking engine 1100 may need to access and analyze the search results in order to set appropriate bids for advertisements so that they can be ranked and served. A variation of such a search-aware ranking system is shown in FIG. 2.

FIG. 2 shows a block diagram of a ranking process that allows for search-contingent bids by advertisers. In the embodiment shown, an advertisement request 4070 is generated at a data access device 4100 concurrently with or as a result of a search request. The advertisement request is sent to an ads server 4110, where it causes an initial ad selection process 4000. The ad selection process 4000 may select ads from an ads database(s) based on keyword relevance, advertiser bid, and/or ad performance data from one or more historical log databases. Variations of the ad performance data may include ad CTR (click-through rate), conversion rate, cost per click, cost per impression, and other relevant factors indicating ad popularity and effectiveness.

The initially selected ads 4000 may then be passed to a ranking system 4130. The ranking system may be an integral part of the ads server 4110 or may be fully or partially embodied in one or more independent applications operating on one or more processors and/or computer systems. In some variations, the ranking system 4130 may identify ads that have conditional bids 4010.

Some variations of conditional bids may include, in addition to the advertiser's normal bid for ad display, a second bid for when the advertiser's ad is (or isn't) in the top x number of search results. Other variations may be percentage-based, with show and no-show bids being determined by whether or not the landing page of and/or product (or service) advertised in the ad occurs in the x % of the search results. Such bid strategies change the meaning of bids because now there is at least one “show” bid and a “no-show” bid for the advertisement. The bid determines the amount the advertiser is to be charged when the ad that is served for presentation is clicked or otherwise associated with an chargeable event, making the amount that an advertiser pays for a particular ad variable based on the search query results associated with that ad presentation event.

Such a contingent bid strategy is useful in ad-supported online and web-based search utilities. The show bid is the amount an advertiser is willing to pay for ad display if one of the first x-number of search results includes the content of the advertisement, the advertised product or service, and/or one or more of the advertiser's websites. The no-show bid is, conversely, the amount an advertiser is willing to pay for ad display if the first x-number of search results do not include one or more results that show, link to, or otherwise include the landing page of the advertisement, the advertised product and/or service, and/or related ad content such as related products from the same advertiser.

For example, an advertisement linking to a manufacturer's website for information about a particular type of single-seat kayak may be in the suite of initially selected ads for a search on “kayaks for sale.” Included in the search results may be a link to an online retailer's website offering the two-seat model of the same kayak for sale. Although neither the landing page of the ad and the search results are the same and/or in the same domain, and the specific products depicted in those landing pages are different, under certain keyword and semantic analysis techniques, the advertisement may be assigned a “show” bid because of the strong similarity between the advertised product and the product in the search result. Similarity could be determined using clustering techniques to identify same/similar product listings on two different web pages and/or documents. Such clustering techniques may include comparing titles, descriptions, prices, and images of the products.

In some variations, a contingent bidding scheme related to search results may involve further layers of complexity, with advertisers willing to pay a certain amount for a no-show bid and different show-bid amounts based on which of the top x-number of search results includes the ad, product, and/or advertiser's site. Awareness of search result rank may be included in the search result information provided to a bid evaluation and assignment system such as the one described herein. In some variations, each search result may be provided along with its attendant rank order in the overall search result list.

In one variation, an advertiser may make a very low bid or may be unwilling to pay anything at all if the advertiser's ad, product, and/or site is the first search result. In another variation, the advertiser may be willing to pay a premium if they are the first search result as this prevents a competitor's ad from being displayed above them. In further variations, an advertiser may wish to bid at a different discount or a premium if they are the second search result, and so on.

The ranking system 4130 identifies ads having such show and no-show bids 4010 based on the parameters of the advertisements themselves and/or via a database lookup that may associate a particular advertiser's bidding strategy with one or more advertisements. The identified ads are the compared against search results 4020 to determine which of the identified ads duplicate information from or are otherwise associated with one or more of the top x-number and/or x-percent of search results. Such comparison may include comparing the URL domains of an ad landing page and a search result destination, comparing phone numbers associated with an ad and a search result, or even comparing physical addresses and/or specific keywords between the two. The clustering techniques discussed for product comparisons may also be applicable in some variations.

Some variations of comparison 4020 may also include a computation of “distance” between an ad and a search result. This can be a similarity analysis or an “edit distance” between an ad and a search result. Such variations are useful in scenarios such as the kayak example mentioned previously. While the ad has a landing page at the manufacturer's website for a one-seat kayak and the search result has a link or a retailer's website for a two-seat kayak, keyword and/or semantic analysis of the advertiser's landing page (and ad keywords) and the search result landing page (and related keywords) may show that the same brand and type of kayak is included in both the ad and the search result, with the difference being only that the ad shows the one-seat model and the search result the two-seat model.

Variations of such keyword and/or semantic analysis may include comparing and/or computing “edit distance” on parameters such as price, image similarity, feature list, product name, product serial number, manufacturer, and, in some variations, product data gleaned from associated user reviews.

Variations of the ad selection process 4000 can flag ads irrespective of bid and based only on relevance. The show/no-show bid evaluation 4050 may then be done based on “edit distance” to the search results as determined in the comparison process 4020. Edit distance is a semantic analysis tool having several variations. In one variation, keywords may be classified into a hierarchy of verticals. For example, “single kayak” and “double kayak” may both fall into a vertical hierarchy of “product”>>“recreation”>>“outdoor”>>“water”>>“boats”>>“kayaks,” but may fall into separate leaf nodes of “single kayak” and “double kayak.” These keywords therefore have six hierarchy levels in common, meaning that the edit distance between them is comparatively small. By contrast, a keyword such as “bicycle” will only have the hierarchy levels of “product”>>“recreation”>>“outdoor” in common with “single kayak,” making the edit distance between these two terms much larger. In such a variation, similarity between keywords may be determined based on a minimum or threshold number of hierarchy levels in common or on a match percentage likelihood derived from matching hierarchy levels.

Further variations of ad selection processes 4000 may also employ relevancy thresholds to avoid irrelevant high bidders during ad selection 4000.

The comparison 4020 may be accomplished by a module such as an Ad Mixer 4190 that may be added to or integrated with the ranking system 4130 or may operate as a stand-alone component/application in conjunction with the ads server 4110. In some variations, search results 4150 are fed/pushed into the ad mixer for comparison 4020. Other variations may be configured to have the ad mixer 4190 actively get the search results 4150 for comparison/matching 4020.

Yet further variations may push search results 4150 to the ad mixer 4020 from a search engine or an intermediate search results collection/staging point. Further variations still may configure the ad mixer 4190 such that it is only engaged/activated to obtain/process search results when the identified ads 4010 include ads with show and no-show bids. In such variations, the ad mixer portion may be fully bypassed in ad selection situations where no ads having show and no-show bids are selected/identified.

In some variations, the comparison scheme 4020 may fix the types of show and no-show bids that an advertiser may make. In a variation that only analyzes the first search result for potential overlap with selected ads, advertisers may only make a show/no-show bid. Similarly, in a variation that analyzes the first x-number of search results (the first 3 or 5 results, for instance) without discriminating between the results based on rank/order, an advertiser may only make a show/no-show bid. In a variation that is sensitive to multiple search results and also to the rank/order of the results, an advertiser may make show/no-show bids of varying amounts based on the particular position of a related search result.

After comparing the ads having conditional bids against the search results, an appropriate bid is selected for each of the compared ads 4050. Show bids are selected for ads where a “show” criteria is met in the first x-number of search results and no-show bids are selected for ads where a “no-show” criteria is met in the first x-number of search results.

More complicated bid strategies are similarly evaluated to select an appropriate bid. For example, a bid strategy where bid A is associated with a show in the first search result, bid B is associated with a show in the second search result, bid C is associated with a show in the third search result, and bid D is associated with any other condition would be evaluated based on whether a “show” criteria was met and which result was the “show” result.

An even more complicated bid strategy, such as one allowing for multiple shows within the first 5 or 10 search results, may also be implemented and similarly analyzed. In one variation, an advertiser could specify a no-show bid and provide one number per slot to be subtracted from the no-show bid to compute the actual bid. E.g. the advertiser could set a no-show bid of 0.50 and subtractive bids of {0.30, 0.30, 0.10, 0.10, 0.02} for the first 5 search slots. In such a variation, if search results and/or content associated with or related to the advertisement and/or the advertiser showed at first and fifth, his actual bid would be 0.50−0.30−0.02=0.18. In such variations, negative computed bids are treated as zero bids.

The ads are then ranked 4040 based on the selected bid, and then served according to their rank order 4060 and also based on the total number of top-ranked ads to be served. The served ads are then received 4080 and presented on the data access device 4100.

In the variation depicted in FIG. 2, ads are still selected 4000 on criteria such as bid and CTR, but the ranking system 4130 now has an awareness of the show and no-show bids 4010 and the search results 4150, and works in concert with an ad mixer 4190 to compare the conditional-bid ads to the search results 4020 and set the proper bid for each conditional-bid ad.

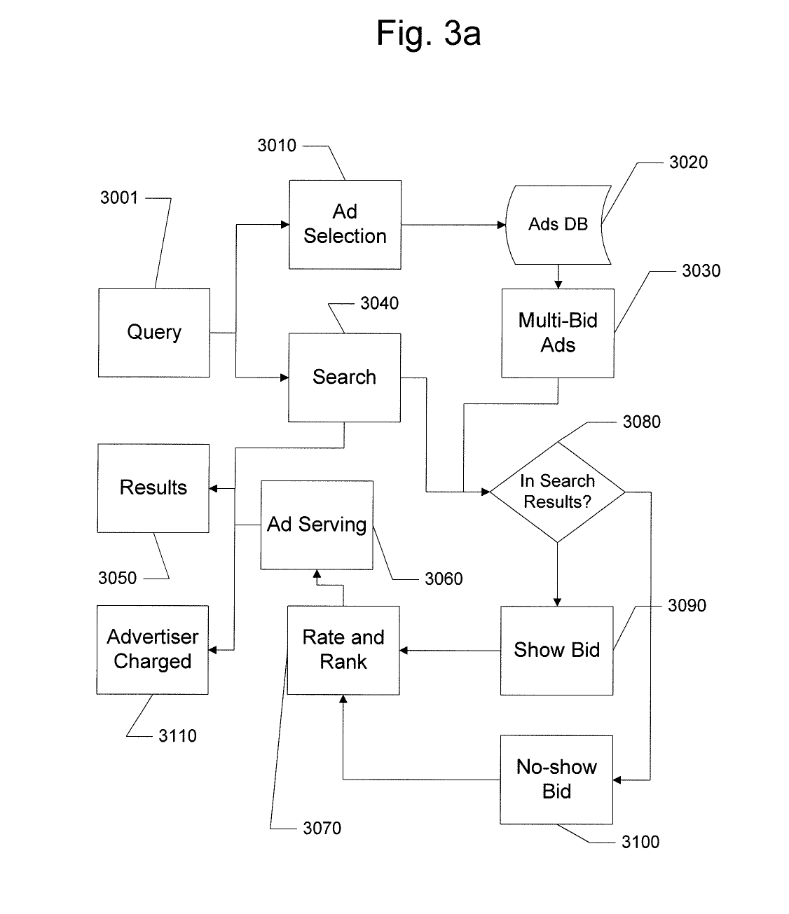

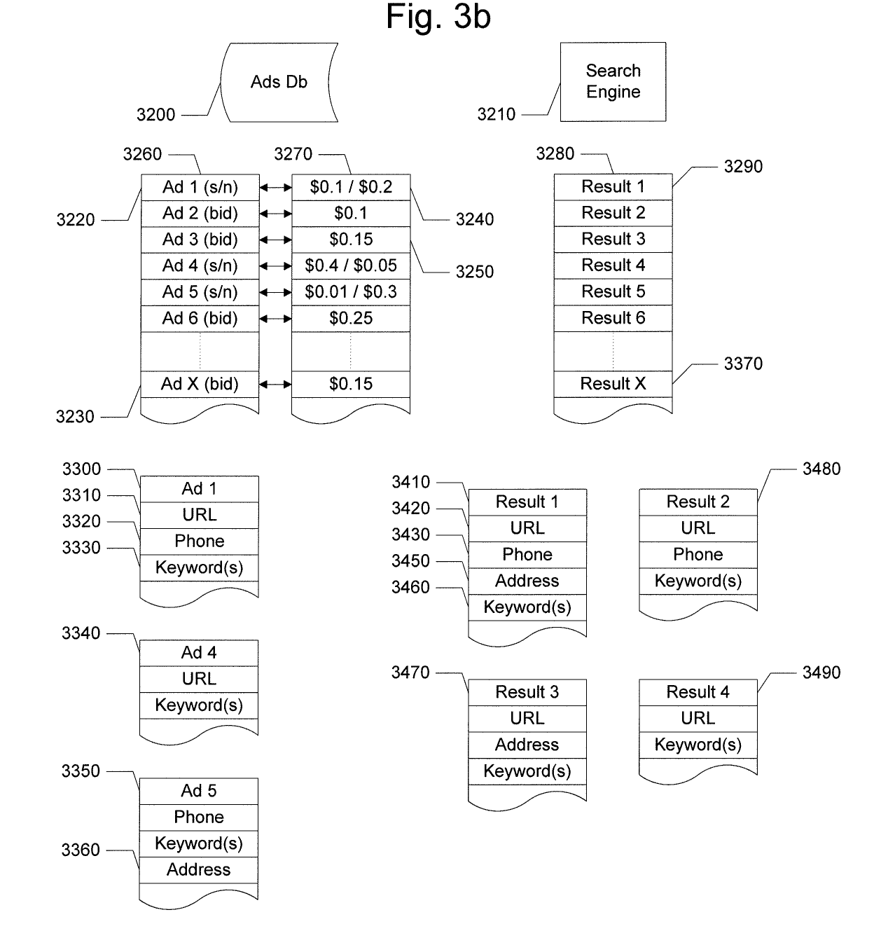

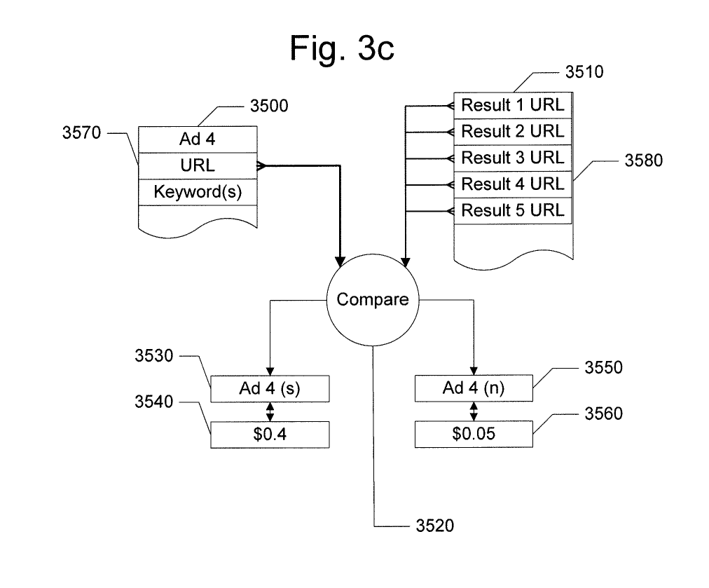

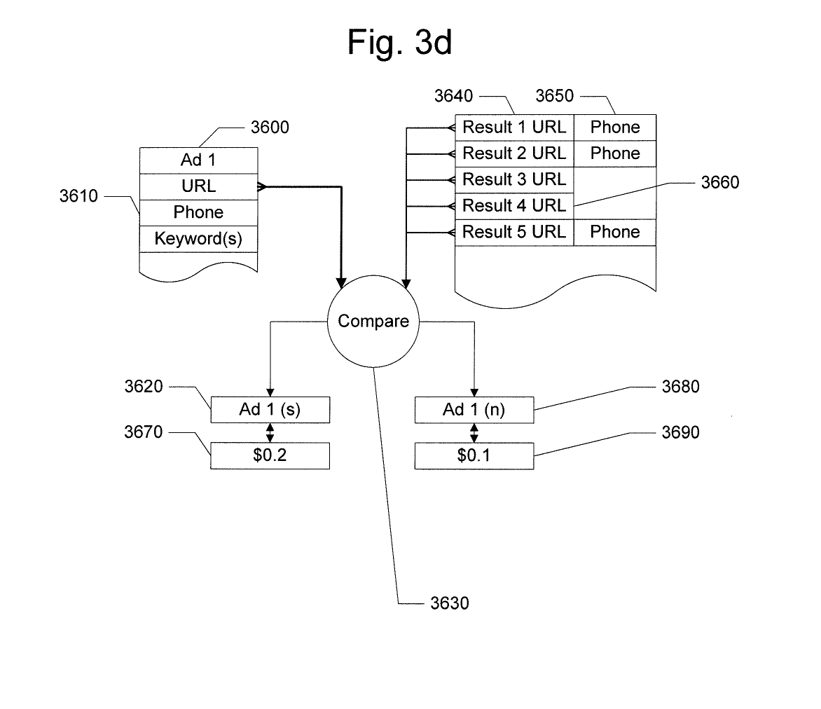

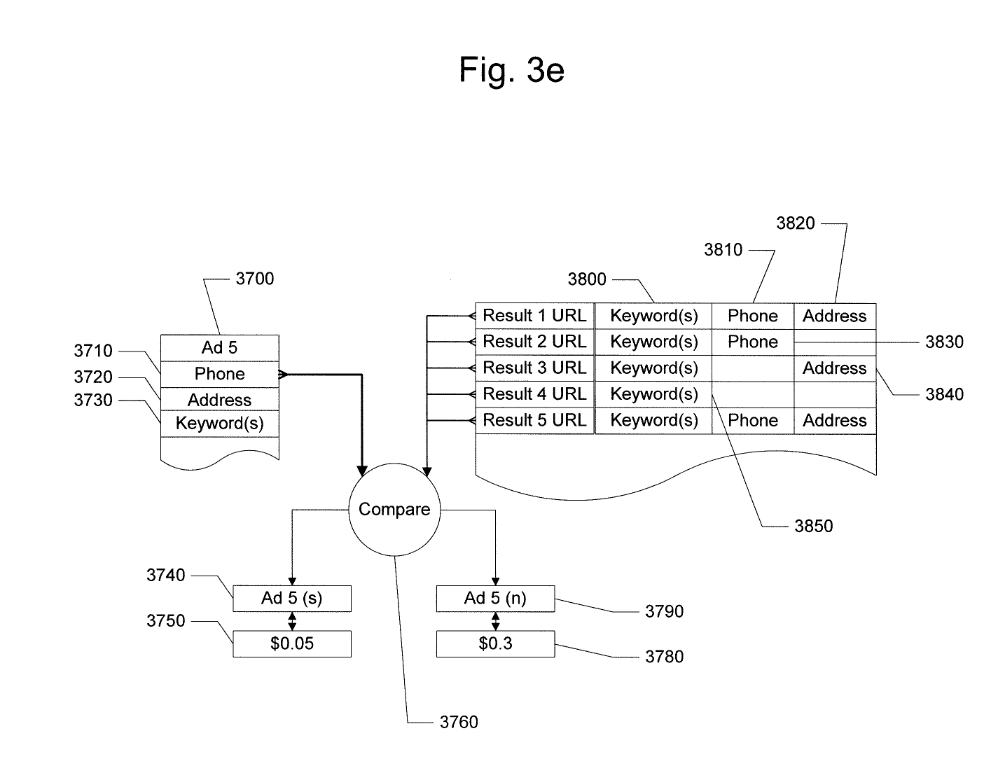

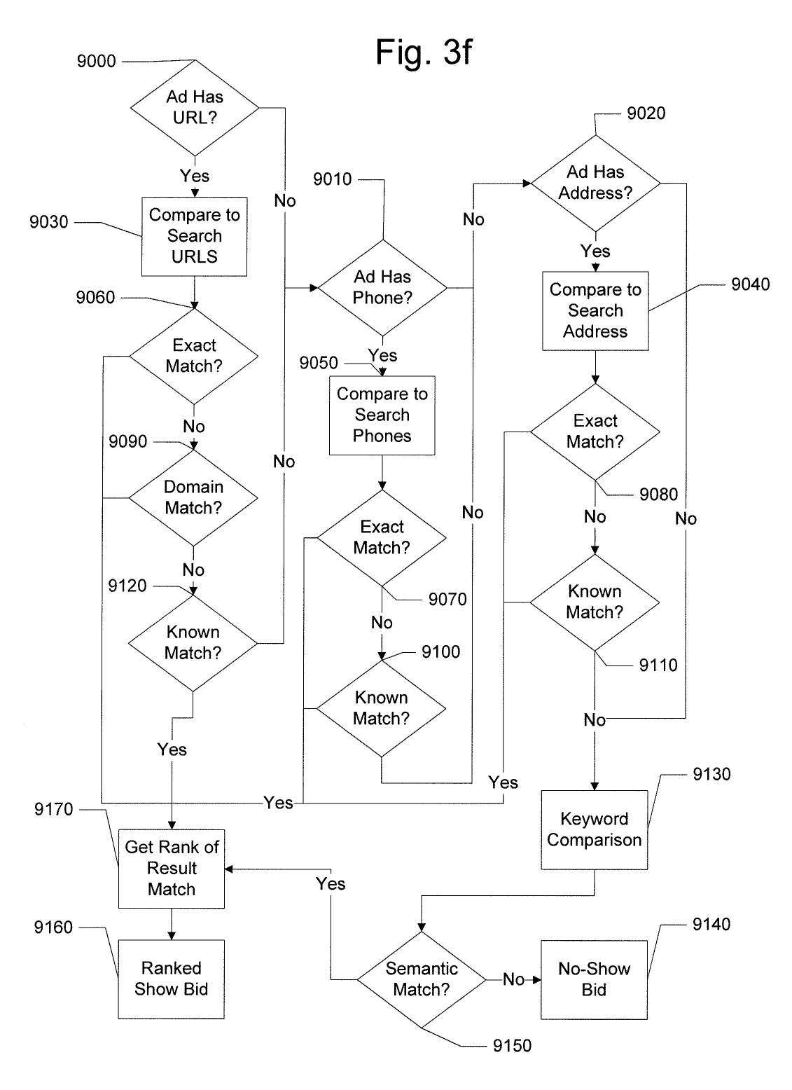

FIG. 3a shows a flowchart of an embodiment of an ad selection, ranking, and serving process that addresses show and now-show bidding strategies for search-based advertisement presentation.

In the embodiment shown, a search query 3001 may be a triggering event for both a search 3040 operation and an attendant ad selection 3010 operation. Variations of a search query 3001 may be performed on a network-based search engine via a website and/or an application accessed from a desktop, laptop, tablet, or hand-held data access platform. Some variations of a query may include a query expansion and/or tailoring operation that searches not only for the terms in the query but also for related terms and/or contexts based on one or more of semantic analysis, querying device location, prior query behavior, and known settings and/or preferences associated with the query and/or querying device.

When submitted to a search engine, the query 3001 may trigger both a search 3040 and an ad selection 3010 process. In some variations, a query expansion may be performed on the submitted query before it is used for search and ad selection. A search 3040 may be a database search, an internet search, a search of specific media and/or content types and/or date ranges and/or languages.

Variations of an ad selection 3010 may be based on the query terms and/or on expanded terms created via a query expansion operation. The ad selection process 3010 may select ads from an ads database 3020 or otherwise direct the ads database 3020 to provide a set of selected ads to a ranking system 3070. In the case of ads having show/no-show conditional bids 3030, such ads are compared against the results of the search 3040 to determine if the subject matter of the multi-bid ads 3030 is in the search results 3080. Such determination may be done with an ad mixer 4190, as shown in FIG. 2, which determines whether each of the multi-bid ads 3030 is in the search results 3080 and either assigns/selects a show bid 3090 or no-show bid 3100 status to each ad or directs a ranking system 4130 to set the bids appropriately before rating and ranking 3070 the ads.

The rating and ranking process 3070 may include any number of ranking schemes based on parameters such as relevance, click-through rate, conversion rate, and bid. Ranking schemes may be auction-based, and may include solutions designed to assign a unique, non-overlapping rank to each ad. Other ranking systems may allow for ties and/or include tie-breaker solutions.

Once the ads are arranged into a rank order 3070, the top x-number of ads are served 3060 for presentation along with the search results 3050. In variations where 2 or more top-ranked ads are served for presentation 3060, the rating and raking 3070 may also include relative position and neighbor bidding, whereby advertisers may bid a certain amount to be in the top-ranked position and bid a different amount to be in a second-ranked position. In some variations, advertisers may bid more for the last-ranked displayed position if they are in the top-ranked search result as this allows them to occupy a larger portion of a presentation medium with their content/message. In other variations, advertisers may employ other bidding strategies that combine relative rank and search results presence awareness.

Depending on the show or no-show status determined for an advertisement relative to the search results 3080, a show 3090 or no-show 3100 bid was assigned. When/if the advertiser is charged 3110 for an ad and/or ad-related event, they are charged based on the assigned show or no-show bid price for the ad serving event.

Variations of bid assignment and bid selection based on analysis and comparison techniques are depicted in FIGS. 3b-f. FIG. 3b shows an embodiment of search results 3280 from a search engine 3210 and an embodiment of ads 3260 from an ads database 3200 and the bids 3270 associated with the ads.

The total number of ads 3230 initially selected from an ads database 3200 may be determined by a pre-set, dynamically calculated, and/or user-defined parameter in an ad selection program and/or program portion. An individual ad may be a single-bid ad 3230 or a show/no-show bid ad 3220. Single-bid ads 3230 are associated with a single advertiser bid 3250, which is the price an advertiser is willing to pay for serving/presenting that ad. Such a single bid 3250 is not variable and does not depend on related events such as the results of a search query.

Show/no-show bid ads 3220, on the other hand, are associated with a show/no-show bid 3240 that has at least two different bid values in it. In some variations, a show bid is a bid that an advertiser makes for advertisement serving/presentation when the subject matter and/or landing page of an ad is included in or otherwise strongly associated with one or more search results, and a no-show bid is a bid that an advertiser makes for advertisement serving/presentation when the subject matter and/or landing page of an ad is not included in and not otherwise strongly associated with at least one search result. Other variations may have multiple show bids that are predicated on an association/connection between an ad and a particular search result (i.e. one show bid for the first result, another for the second, etc.).

In addition to being associated with a bid, an advertisement 3300 may include the URL of a landing page 3310, one or more ad keywords 3330, and other information such as an address 3360 or a phone number 3320. Some variations of advertisements 3340 include only a URL and keywords. Other variations of advertisements 3350 are not associated with a URL. Such advertisements may be click-to-call or click-to-chat or static display ads not connected with a particular landing page.

The total number of search results 3370 sent/acquired from the search engine 3210 may be determined based on the particular logic/parameters of a show/no-show bid scheme. In some variations, only the top search result 3290 or the top x-number of search results 3280 may be of interest.

A search result 3410 may include a URL/link 3420 to a document and/or web page. Some variations may also include a phone number 3430, address 3450, and/or associated keywords 3460. Some search result variations 3490 may have only a URL and keywords, whereas others may include an address 3470 or a phone 3480 but not both.

In one variation of an ad-to-result comparison and bid selection process, shown in FIG. 3c, an advertisement 3500 may have its landing page URL 3570 compared 3520 against a list of search result URLs 3510. The ad URL 3570 may be compared against each of the listed result URLS 3580 to determine if any of the results match. A match may be determined if there is an exact URL match, or if the two URLs are from the same domain (both point to a page within the Toyota.com domain, for instance).

If a match is determined, the ad is flagged as a “show” ad 3530 and has its bid set to the “show” bid value 3540. If a match is not determined, the ad is flagged as a “no-show” ad 3550 and has its bid set to the “now-show” bid value 3560.

In another variation of an ad-to-result comparison and bid selection process, shown in FIG. 3d, an advertisement 3600 may have its landing page URL 3570 and phone number 3610 compared 3630 against a list of search result URLs 3640 and phone numbers 3650. The URL match determination may be performed as discussed above. The phone number determination may be checked for either an exact match or a match to a known list of numbers and/or exchanges. For example, an ad phone number 3610 may not be an exact match to a search result phone number 3650 but both numbers may be known to be associated with the same merchant/manufacturer/etc. In other variations, a particular entity may be known to have a block of phone numbers of a certain format/type. A corporation or agency, for instance, may have a block of phone numbers of a known format. Some search results may have only a URL and no phone number 3660.

As discussed above, if a match is determined, the ad is flagged as a “show” ad 3620 and has its bid set to the “show” bid value 3670. If a match is not determined, the ad is flagged as a “no-show” ad 3680 and has its bid set to the “now-show” bid value 3690. In this variation, a match may be determined on the basis of a URL or a phone number. In some variations, both the URL and the phone number may be required to match, in other variations a phone number match may be a verification tool to confirm a URL match, in yet further variations, a match on either the URL or the phone number may be sufficient for “show” status of an ad.

In yet another variation of an ad-to-result comparison and bid selection process, shown in FIG. 3e, an advertisement 3700 may have one or more of a phone number 3710, address 3720, and keywords 3730 compared against search result phone numbers 3810, addresses 3820 and keywords 3800. In some such variations, an ad may not have a URL, the URL comparison aspect may be skipped, or the URL comparison, as shown in FIG. 3c, may be carried out independently of and/or in parallel with the comparison variation of FIG. 3e.

In some variations, there may be search results having no address 3830, no phone number 3840, or neither address nor phone number 3850. Phone number comparison 3760 may be carried out as discussed above. Address comparison may be carried out similarly, first looking for a possible exact match between an ad address 3720 and a search result address 3820 and then looking to see if the two addresses are both associated with the advertiser.

Keyword matching may be carried out by techniques such as comparing titles of the destination pages, common keywords, frequency of keyword overlap, overall page word count, product names and/or images listed thereon, feature lists, and other sources of identifying page and/or product information. Additionally, contextual analysis tools may be employed to resolve ambiguities such as determining the proper meaning of the word “lead” when referring to a pipe material as compared to the word “lead” when referring to an electrode.

If a match is determined, the ad is flagged as a “show” ad 3740 and has its bid set to the “show” bid value 3750. If a match is not determined, the ad is flagged as a “no-show” ad 3790 and has its bid set to the “now-show” bid value 3780. In this variations, a match may be determined on the basis of a phone number, an address, or a keyword match or some combination thereof. One or more parameter may be used to check/verify one or more of the others in some variations. In other variations, a match on any parameter may be sufficient. In yet further variations, URL comparison/matching may be included in the comparison 3760 or may be carried out as a separate comparison procedure and compared/verified by a parameter-based one of the type depicted in FIG. 3e.

A flowchart depicting an embodiment of an overall comparison/matching process for identifying ads, ad content, ad landing page targets, and ad-related content within search results is depicted in FIG. 3f. In the variation shown, the process may begin by checking whether the ad in question has a URL 9000. If the ad has a URL, a URL search comparison process 9030 may be executed to determine if the URL is an exact match 9060, a domain match 9090, or an otherwise known match 9120 with a search result. Otherwise known matches may include things like international sites having different domains (Toyota.com and Toyota.co.jp, for example) or a site for a primary/main retailer of a particular manufacturer's goods (Sears and Craftsman, for example). In a rank-sensitive variation, a match may also require the rank of the result match 9170 to set an appropriate show bid 9160. Rank-insensitive variations may simply set a show bid 9160 without regard for rank.

If a match cannot be determined by URL, or if the ad does not have a URL, the ad may be checked for a phone number 9010. If the ad has a phone number, a phone number comparison process 9050 may be executed to determine if the ad phone number is an exact match 9070 or a known match 9100 with any of the search result phone numbers. If a match is determined, a show bid 9160 may be set (and may be rank-based 9170) as discussed above.

If a match is not determined or an ad does not have a phone number, the ad may be checked for an address 9020. If the ad has an address, an address comparison process 9040 may be executed to determine if the ad address is an exact match 9080 or a known match 9110 with any of the search result addresses. If a match is determined, a show bid 9160 may be set (and may be rank-based 9170) as discussed above.

If an ad has no URL, no phone, and no address, or if a match cannot be determined on one or more of these factors, a keyword comparison process 9130 may be executed to determine if there is a sufficient keyword/semantic match 9150 between the ad keywords and the search result keywords. This may be accomplished by one or more of the keyword matching techniques mentioned above. If a match is determined, a show bid 9160 may be set (and may be rank-based 9170) as discussed above.

If no match can be determined on any of keyword, address, phone, and/or URL, the ad may be determined to be a no-show ad and a no-show bid may be set for it 9140.

In some variations, the URL, address, phone, and/or keyword evaluations may be conducted independently and/or in parallel, without depending from each-other. In such situations, the result of each comparison may be combined with the results of the other comparisons to give a final match likelihood rank/rating that may be used to decide the show/no-show status of the ad.

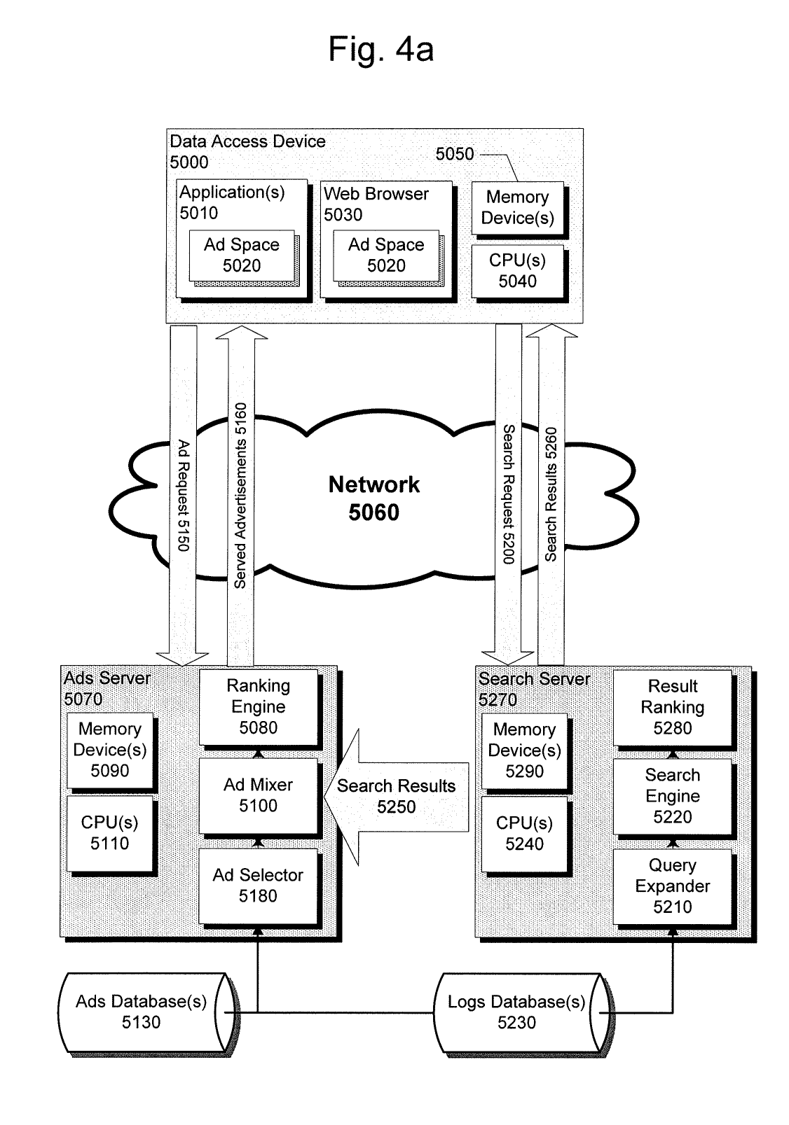

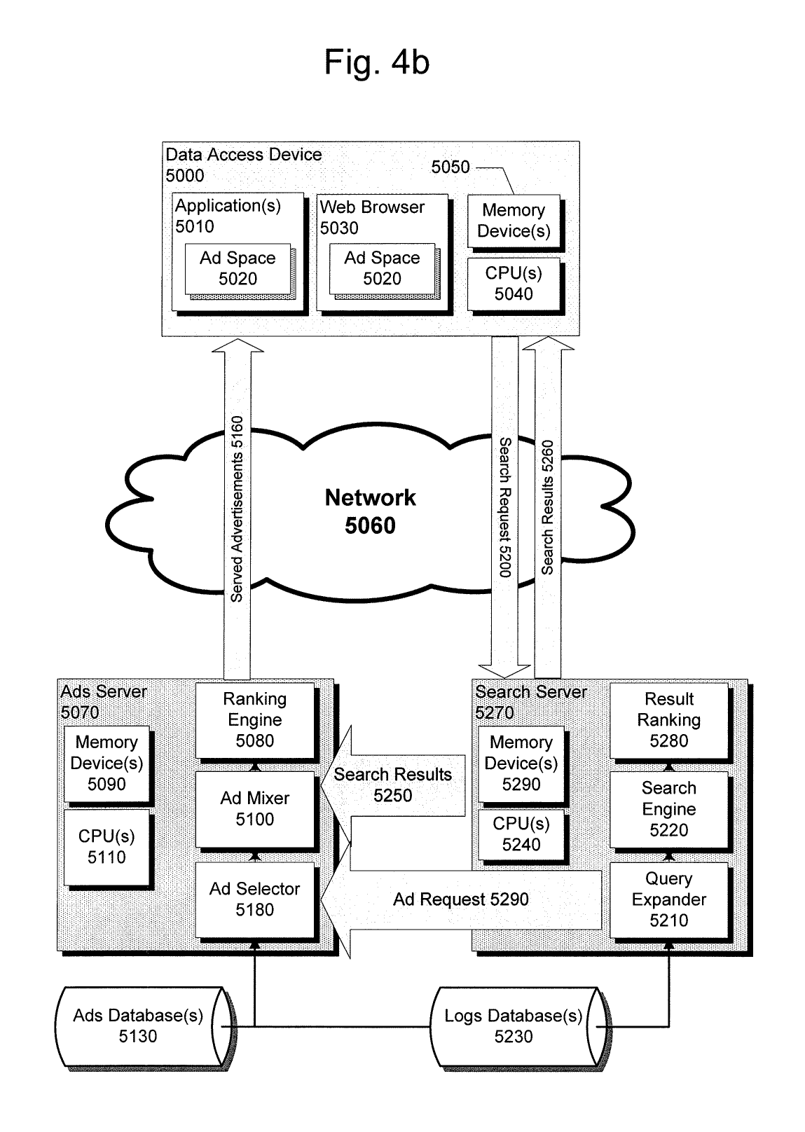

Variations of the process shown in FIGS. 3a-f may be embodied in one or more computing and/or data processing systems connected by one or more networks. An example of an ad server working in conjunction with a search server to enable awareness of advertiser presence in search results is depicted in FIG. 4a.

FIG. 4a depicts a block diagram of an embodiment of an ad serving system 5070 that employs an ad ranking engine 5080 and an ad mixer 5100 that makes the ad serving system 5070 aware of search query results 5250 to serve relevant ads 5160 in response to requests 5150 from a data access device 5000.

In the embodiment shown, a data access device 5000 communicates with an ads server 5070 and a search server 5270 over a network 5060. Embodiments of a data access device 5000 may include a mobile device such as a cellular phone, personal digital assistant, smart-phone, GPS device, tablet, media player or presentation device, netbook and/or notebook computer, or other portable or semi-portable computing and/or data access and presentation device. Other embodiments of a data access device 5000 may include desktop or fixed location computing and/or media access devices, information kiosks, and virtual devices such as software applications, media access programs, and/or web browsing tools.

Embodiments of a data access device 5000 may include one or more memory devices 5050 for information storage and one or more processors 5040 for data processing. The memory devices(s) 5050 and processor(s) 5040 may operate in concert to run one or more applications 5010 such as data exchange, media display, information search, social network, game and/or GPS/location programs.

In some variations, one or more of these applications 5010 may be equipped with ad space 5020 for the display and/or presentation of ads 5160 transmitted via the network 5060 to the data access device 5000 from one or more ad servers 5070. The memory 5050 and processor 5040 may also operate in concert to run one or more web browsing applications or services 5030. Embodiments of a web browser may include application- or app-based browsers or a built-in web browsing tool included in an operating system. Embodiments of a web browser 5030 may also be equipped with ad space 5020 for the display and/or presentation of ads 5160 transmitted via the network 5060 to the data access device 5000 from one or more ad services.

Embodiments of applications 5010 and web browsers 5030 may also include search tools and/or capability for access to website and/or remote services offering search capability. Such applications 5010 and web browsers 5030 may be configures and/or capable for presentation of search results 5260 from one or more search engines or search servers 5270, via a network 5060, in response to a search query/request 5200 from the data access device 5000.

Embodiments of a network 5060 may include public, private, cellular, telephone, radio-frequency, Ethernet, optical, encrypted, open, IP-based, wide-area, local-area, and/or hard-wired data transfer pathways, and/or combinations thereof, suitable for exchange of information between two or more devices connected thereby.

Embodiments of an ads server 5070 may include one or more computing devices or components thereof, which may be configured to operate collectively, independently, or otherwise collaboratively to serve ads 5160 in response to advertisement requests 5150 from a data access device 5000.

Embodiments of an ads server 5070 may include one or more memory devices 5090 for information storage and one or more processors 5110 for data processing. The memory device(s) 5090 and processor(s) 5110 may operate in concert to execute the various functions and aspects and run the associated applications of the ads server. In some variations, an ads server may be equipped with modules, functional units, sub-systems, or programs/applications or portions thereof that perform ad selection 5180 and ranking 5080 (and the attendant log database 5230 and ad database 5130 interface features), and, in ad-mixing variations, mixing ads 5100 with search results 5250.

Embodiments of ad selection 5180 and ranking 5080 systems may function independently, collectively, and/or interoperably. In some variations, the ad ranking system 5080 may be an associated dedicated server connected to or integrated with an ads database 5130. In other variations, an ad selection 5180 and ranking tool 5080 may be a program or a functional module of an overall ads server application or applications suite. The ad selection 5180 and ranking 5080 aspects may be configured to access or otherwise interface with an ads database 5130 in order to identify and extract from the ads database 5130 ads relevant to an incoming ad request 5150.

Embodiments of ad selection 5180 and ranking 5080 systems may include a ranking feature that ranks each extracted advertisement according to one or more ranking schemes such as auctions, joint-ranking models, and/or other ranking schemes. Embodiments may also include a keyword analysis and/or semantic analysis and search feature that enables an ad selector 5180 to select relevant ads from the ads database 5130 in response to the ad request 5150.

Embodiments of a ranking system 5080 may be realized through programs or program modules running on the ad server(s) 5070 and/or through dedicated hardware systems or modules for the express purpose of ranking ads. In some embodiments, the ranking system may be functionally intertwined with the ad selector 5080 such that both are part of the same program, program portion and/or hardware system or module.

In some variations, an ad serving system 5070 may have a distinct ad selector portion 5180 separate from a ranking system 5080 or may be comprised of a collection of disparate specialized sub-systems. In some variations, an ad selector 5180 may be a specialized database querying unit that is configured to quickly retrieve advertisements from an ads database 5130 based on a relevance determination process performed on an incoming ad request 5150. In other variations, an ad selector 5180 may be a filtering unit configured to winnow down relevant ads identified and retrieved or otherwise indicated from one or more ads databases 5130 by a relevance determination process carried out separately from the ad selector 5180. In yet other variations, the ad selection aspect 5180 may be an integral part of the ranking engine 5080.

In some variations, the ranking system 5080 may be configured to address/enable an advertiser bidding strategy whereby a bid for an ad display event is conditioned upon results of a query or search associated with that ad display event. In such variations, a data access device 5000 may, via a web browser 5030 or application 5010, input a query 5200 into some form of search engine 5270, such as a web or internet search engine. The query may also trigger an advertisement request 5150 based on the query terms. An ad selector 5180, upon receipt of the ad request 5150, may select some advertisements having a bid predicated on whether a link and/or site associated with that advertisement is included in the search results for the query. In such a variation, the ranking engine 5080 may need to access and analyze or otherwise have an awareness of the search results 5250 in order to set appropriate bids for advertisements so that they can be ranked and served.

In such variations, an ad mixer 5100 may be included in the ads server 5070 for the purpose of reconciling and/or comparing ads selected by the ad selector 5180 against/with the search results 5250 provided by the search engine/server 5270. In some variations, the ad mixer 5100 may be an associated dedicated server connected to or integrated with either or both of the ad selector 5180 and ranking engine 5080 aspects of the ad server 5070. In other variations, an ad mixing tool 5100 may be a program or a functional module of an overall ads server application or applications suite. The ad mixing 5100 aspects may be configured to access or otherwise interface with ad selection 5180 and ranking 5080 programs/servers as well as to receive and/or fetch a set or stream of search results 5250 from a search engine/server 5270.

The ad mixer 5100 informs the ranking engine 5080 as to which of the ads from the ad selector 5180 are associated with a show/no-show bid strategy and also which of those show/no-show bids are present in the top x-number of search results 5250. In some variations, the ad mixer 5100 may also provide an awareness of which of the top x-number of search results 5250 include content related to which ad. In further variations, the ad mixer may set a show/no-show bid for a show/no-show ad based on whether and/or where it (or its attendant content) occurs in the search results.

The ranking engine 5080 may then rank the mixed advertisements based on either the appropriate bid or appropriate bid-setting information provided by the ad mixer 5080. The ads server 5070 may then serve 5160 the top x-number of ranked advertisements to the data access device 5000 for presentation in the ad space(s) 5020 or other areas of an application 5010 of web browser 5030 associated with a search request 5200.

In some variations, the search request 5200 is transmitted from the data access device 5000 concurrently and/or simultaneously with the ad request 5150. Whereas the ad request is directed to an ads server 5070, the search request 5200 is directed to a search engine and/or search server 5270.

Similarly to an ads server 5070, embodiments of a search server 5270 may include one or more computing devices or components thereof, which may be configured to operate collectively, independently, or otherwise collaboratively to serve search results 5260 in response to search requests 5200 from a data access device 5000.

Embodiments of a search server 5270 may include one or more memory devices 5290 for information storage and one or more processors 5240 for data processing. The memory device(s) 5290 and processor(s) 5240 may operate in concert to execute the various functions and aspects and run the associated applications of the search server. In some variations, a search server may be equipped with modules, functional units, sub-systems, or programs/applications or portions thereof that perform query expansion 5210, search 5220 (and the attendant log database 5230 interface features), and result ranking 5280.

In some variations, the search results 5260 returned to a data access device may be different from the search results 5250 fed/pushed to an ad mixer 5100. In variations where the conditional, show/no-show bid strategy is limited to looking at only the top x-number of search results, only those search results 5250 may be sent/pushed to the ad mixer 5100. By avoiding transmission of irrelevant/excess data, the operation of the ad mixer may be more efficient, thereby improving overall system performance and decreasing response time.

In some variations, the data access device 5000 only generates a search request 5200, with the advertisement request 5290 being generated by the search server 5270 after receipt of the search request 5200. Such a variation is shown in FIG. 4b. In the variation shown, a search request 5200 from the data access device is submitted to a search server 5270, where it may undergo query expansion 5210. The expanded query may then be used by the search server to both perform a search 5220 and also sent an expanded advertisement request 5290 to the ads server 5070. In such a variation, performing query expansion before generating an advertisement request ensures that the search results and selected ads will be more appropriately matched.

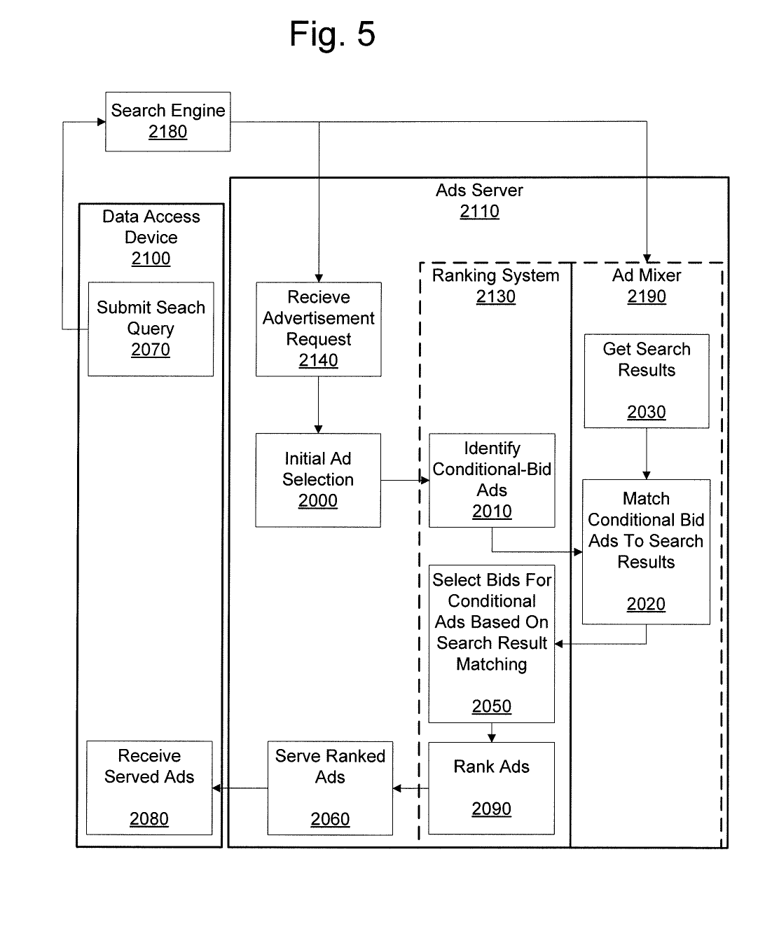

FIG. 5 shows a block diagram of a ranking process that allows for search-contingent bids by advertisers. In the embodiment shown, an advertisement request is received 2140 at an ads server 2110 as a result of a search query 2070 submitted from a data access device 2100 to a search engine 2190, which generates and transmits the advertisement request to the ads server 2110. The advertisement request causes an initial ad selection process 2000. The ad selection process 2000 may select ads from an ads database(s) based on keyword relevance, advertiser bid, and/or ad performance data from one or more historical log databases. Variations of the ad performance data may include ad CTR (click-through rate), conversion rate, cost per click, cost per impression, and other relevant factors indicating ad popularity and effectiveness.

The initially selected ads 2000 may then be passed to a ranking system 2130. The ranking system may be an integral part of the ads server 2110 or may be fully or partially embodied in one or more independent applications operating on one or more processors and/or computer systems. In some variations, the ranking system 2130 may identify ads that have conditional bids 2010 such as variations of the show/no-show bids and bidding schemes/strategies discussed herein.

The ranking system 2130 identifies ads having such show and no-show bids 2010 based on the parameters of the advertisements themselves and/or via a database lookup that may associate a particular advertiser's bidding strategy with one or more advertisements. The identified ads are matched to/compared against search results 2020 to determine which of the identified ads are in the top x-number of search results. Such matching and/or comparison may include some or all of the previously-discussed comparison methods and schemes, including relevancy, semantic/“edit” distance, and URL/phone number/address comparisons. Further variations may also employ relevancy thresholds to avoid irrelevant high bidders during ad selection 2000.

The comparison/matching 2020 may be accomplished by a module such as an Ad Mixer 2190 that may be added to or integrated with the ranking system 2130 or may operate as a stand-alone component/application in conjunction with the ads server 2110. In the variation shown, the ad mixer 2190 gets the search results 2030 from the search engine 2190. In other variations, the search engine 2190 may push the search results to the ad mixer 2190 for comparison 2020.

Variations of matching and/or comparison scheme 2020 may include some or all of the search result evaluation and comparison schemes and methods discussed previously herein.

After matching the ads having conditional bids with the search results 2020, an appropriate bid is selected for each of the compared ads 2050. Bid selection may be accomplished according to some or all of the bid selection schemes and methods discussed previously herein.

The ads are then ranked 2090 based on the selected bid, and then served according to their rank order 2060 and also based on the total number of top-ranked ads to be served. The served ads are then received 2080 and presented on the data access device 2100.

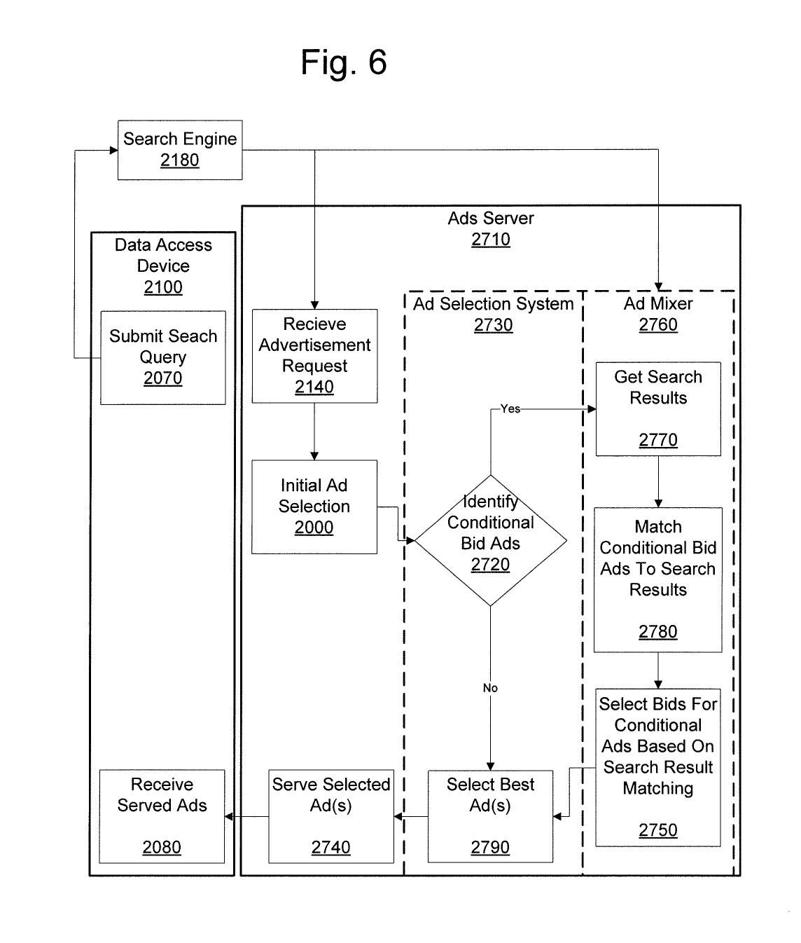

Some variations of a show and no-show bid assignment technique may be accomplished without the use of a ranking system/engine. Some such variations may employ a multi-step bid selection process. Such a variation is depicted in FIG. 6.

The ads server 2710 in FIG. 6 is equipped with an ad selection system 2730 instead of and/or in addition to a ranking engine. After an initial ad selection operation 2000 based on relevance, ad performance, and other factors, the ad selection system 2730 may determine if there are any ads having show and no-show bid ads present 2720 in the initially selected set. If no such ads are present, the ad selection system 2730 selects the best ads 2790 from the initial set and the ads server 2710 serves those ads 2740.

The ad selection system 2730 may employ a wide range of differing criteria to select one or more ads as being the “best.” In some variations, selection may be based purely on highest bidder, in other variations, selection may be based on a metric computed from a composite of bid, CTR, and/or other indicators such as keyword relevance, conversion rate, and other factors indicating likelihood of ad click. In yet further variations, best ad selection 2790 may select more than one “best” ad. In further variations still, best ad selection 2790 may select a first “best” ad based primarily on a predicted likelihood of click and a second “best” ad based primarily on bid. Further variations still may select any number of “best” ads according to various and varied set(s) of criteria on an overall or per-ad basis.

If it is determined 2720 that ads having show and no-show bids are present in the initially selected set, the ad selection system 2730 may invoke/activate or otherwise communicate with an ad mixer 2760 to get search results 2770 from the search engine 2180.

The ad mixer portion 2760 may then match the show and no-show bid ads to the search results 2780 and select and/or assign the appropriate bids for individual ads 2750 before sending the ads to the best ad selection unit 2790. Matching and bid selection in such a variation may operate in any of the ways previously described herein. The best ad selection 2790 in such a variation may operate as discussed above with respect to the scenario having no ads with show/no-show bids.

Further variations may include a ranking system implemented as part of all of the best ad selection 2790 aspect. In yet further variations, a ranking system may by implemented in addition to the ad selection system 2730 so that a group of selected “best” ads 2790 may then be ranked before serving 2740.

Further variations still may always engage the ad mixer 2760 to pull in and/or receive search results 2770 regardless of whether the initial ad selection 2000 includes ads with show and no-show bids.

Only exemplary embodiments of the present invention are shown and described in the present disclosure. It is to be understood that the present invention is capable of use in various other combinations and environments and is capable of changes or modifications within the scope of the inventive concept as expressed herein. It is to be further understood that techniques and methods discussed herein related to operation and configuration of computer systems may be embodied on non-transitory computer-readable media for execution on a computing device or system of computing devices. Such variations are not to be regarded as departure from the spirit and scope of the invention, and all such modifications as would be obvious to one skilled in the art are intended to be included within the scope of the following claims:

We claim:

1. A method of dynamically establishing a bid for a search advertisement having a show bid and a no-show bid, the method comprising:
selecting at least one advertisement for display in response to a user-initiated search, said advertisement having an associated show bid and a no-show bid;
determining if the selected at least one advertisement is associated with at least one of a predetermined number of top-ranked search results;
setting a show bid for said at least one advertisement if said determining indicates that said at least one advertisement is associated with said search results;
setting a no-show bid for said at least one advertisement if said determining indicates that said at least one advertisement is not associated with said search results; and
serving at least one of said at least one advertisement along with said search results.

2. A method of serving an advertisement to a data access device along with search results, the method comprising:
receiving an advertisement request at an ads server; performing an initial ad selection based on said advertisement request;
identifying, from among the initially selected ads, those ads having show and no-show bids;
receiving, in an ad mixer portion of the ads server, the search results;
comparing the identified ads with the search results to determine which of the search results are associated with at least one identified ad;
if a search result is determined to be associated with a particular identified ad, selecting a show bid for that identified ad;
if no search result is determine to be associated with a particular identified ad, selecting a no-show bid for that identified ad; and
serving at least one particular identified ad in response to the advertisement request.

3. The method of claim 2, where said receiving the search results includes getting search results from a search engine with the ad mixer.

4. The method of claim 2, where said receiving an advertisement request includes receiving an advertisement request from at least one of a search engine and a search engine proxy.

5. The method of claim 4, where the advertisement request from the search engine is based on query-expanded search terms.

6. The method of claim 3, where said getting includes getting the top three search results.

7. The method of claim 2, said serving including ranking the compared ads according to the bid selected for each ad; and serving one or more top-ranked ads in response to the advertisement request.

8. The method of claim 2, said serving including serving said ad for presentation along with said search results.

9. The method of claim 1, where said serving includes serving the top-ranked ad.

10. The method of claim 1, where said determining includes comparing said top-ranked search results to the advertisement according to at least one of URL, phone number, address, and keyword.

11. The method of claim 1, where said serving includes ranking and rating at least two advertisements based on their associated bids; and serving one or more advertisements based on their rank and rating.

12. The method of claim 1, where said determining includes comparing an edit distance between at least one keyword in said advertisement and at least one keyword in said search results.

13. The method of claim 1, said setting a show bid including subtracting a show decrement amount from the no-show bid to establish a show bid, said show decrement amount being established by the advertiser for said advertisement.

14. The method of claim 13, said show decrement amount including at least a first show decrement amount associated with a first-ranked search result and a second show decrement amount associated with a second-ranked search result,
wherein said setting a show bid step includes
subtracting the first show decrement amount when said determining indicates said advertisement is associated with a first-ranked search result and
subtracting the second show decrement amount when said determining indicates said advertisement is associated with a second-ranked search result; and
further wherein a show-bid amount of less than zero is treated as a zero bid.

15. A non-transitory computer-readable medium having embodied thereon a program which, when executed by one or more processors, causes said processors to perform part of all of a method of dynamically establishing a bid for a search advertisement having a show bid and a no-show bid, the method comprising:
selecting at least one advertisement for display in response to a user-initiated search, said advertisement having an associated show bid and a no-show bid;
determining if the selected at least one advertisement is associated with at least one of a predetermined number of top-ranked search results;
setting a show bid for said at least one advertisement if said determining indicates that said at least one advertisement is associated with said search results;
setting a no-show bid for said at least one advertisement if said determining indicates that said at least one advertisement is not associated with said search results; and
serving at least one of said at least one advertisement along with said search result.

16. A non-transitory computer-readable medium having embodied thereon a program which, when executed by one or more processors, causes said processors to perform part of all of a method of serving an advertisement to a data access device along with search results, the method comprising:
receiving an advertisement request at an ads server; performing an initial ad selection based on said advertisement request;
identifying, from among the initially selected ads, those ads having show and no-show bids;
receiving, in an ad mixer portion of the ads server, the search results;
comparing the identified ads with the search results to determine which of the search results are associated with at least one identified ad;
if a search result is determined to be associated with a particular identified ad, selecting a show bid for that identified ad;
if no search result is determine to be associated with a particular identified ad, selecting a no-show bid for that identified ad; and
serving at least one particular identified ad in response to the advertisement request.

17. An ads server configured to serve search ads having a show bid and a no-show bid in conjunction with search results, the server comprising:
an advertisement request reception portion that receives an advertisement request;
an initial ad selection portion that selects an initial set of ads from an ads database based on the advertisement request;
a conditional bid ad identification portion that identifies result-contingent ads in the initial set having show bids and no-show bids;
an ad mixer portion that
receives search results associated with the advertisement request from a search engine; and
determines if each of the result-contingent ads is associated with at least one of the received search results;
a bid selection portion that
selects a show bid for a result-contingent ad when the ad mixer determines that the result-contingent ad is associated with at least one of the received search results; and
selects a no-show bid for a result-contingent ad when the ad mixer determines that the result-contingent ad is not associated with at least one of the received search results;
such that each of the initially selected ads is associated with a single bid value as a result of bid selection;
a best ad selection portion that best selects one or more ads according to one or more selection criteria from among the bid selected ads; and
an ad serving portion that serves one or more of the best selected ads.

18. The server of claim 17, where the best ad selection portion is an ad ranking system that ranks the bid selected ads according to at least one of bid, click-through-rate (CTR), and keyword relevance and best selects at least one top-ranked ad.

19. The server of claim 17, where the bid selection portion is included in the ad mixer.

20. The server of claim 17, where the ad mixer and bid selection portions are not engaged in the ad serving process when the conditional bid identification portion does not identify any result-contingent ads in the initial set.
